(19) United States
(12) Patent Application Publication
(10) Pub. No.: US 2007/0197678 A1
(43) Pub. Date: Aug. 23, 2007

(54) PROCESS FOR PRODUCING SILOXANE-CONTAINING RELEASE COATINGS

(75) Inventors: Pedro Cavaleiro, Viersen (DE); Hardi Doehler, Duesseldorf (DE); Michael Ferenz, Essen (DE); Winfried Hamann, Essen (DE); Stefan Silber, Krefeld (DE); Philipp Tomuschat, Essen (DE); Joachim Venzmer, Essen (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/677,244

(22) Filed: Feb. 21, 2007

(30) Foreign Application Priority Data
Feb. 21, 2006 (DE) 10 2006 008 387.3

(51) Int. Cl. C08F 2/46; C08L 83/04

(52) U.S. Cl. 522/99; 526/279; 525/477; 524/588

(57) ABSTRACT

The invention provides a process for producing siloxane-containing release coatings which comprises curing a siloxane-containing coating material by irradiation with microwaves.

This application claims benefit under 35 U.S.C. 119(a) of German patent application DE 10 2006 008 387.3, filed on 21 Feb. 2006.

Any foregoing applications including German patent application DE 10 2006 008 387.3, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The present invention describes a process for producing siloxane-containing release coatings which comprises curing a siloxane-containing coating material by irradiation with microwaves.

Use of Siloxane-Containing Coating Materials

Siloxane-containing coating materials are used relatively widely for coating sheetlike materials, in order to reduce the tendency of adhesive products to adhere to these surfaces.

Siloxane-containing coating materials are used, for example, for the coating of papers or films which are intended to serve as backings for self-adhesive labels. The labels, provided with a pressure-sensitive adhesive, still adheres sufficiently to the coated surface to allow the handling of the backing sheets bearing the adhesive labels. The adhesion of the adhesive labels to the backing sheets must be sufficiently high to rule out premature detachment of the labels in the course of their machine application, as they run over deflecting rollers. On the other hand, however, it must be possible to peel the labels from the coated backing sheet without substantially affecting their bond strength for the subsequent utility.

Siloxane-containing release coatings are also used for producing adhesive tapes, in order, for example, to set a controlled unwind behavior. Further possible applications of substrates having abhesive properties are as packaging papers and packaging films, which serve in particular for packaging sticky articles. Products of this kind are used, for example, for the packaging of foodstuffs, consumer goods, such as tampons, or for packaging industrial products, such as bitumen, for example.

A further application of siloxane-containing coating materials is in the production of touch-and-close fastenings, as in the case of diapers, for example. If the abhesiveness is too high, the diaper does not stay reliably closed. If the abhesiveness is too low, the closure can no longer be opened without tearing the diaper.

State of the Art

Siloxane-containing release coatings have been produced in the art using reactive siloxanes which are crosslinked by exposure to temperature, by ultraviolet radiation (UV) or by electron beams. In general a suitable catalyst or initiator is added, which is activated by temperature exposure, UV radiation or electron beams and so initiates the chemical reaction that leads to curing.

Thermally curable, siloxane-containing coating materials are described numerously in the patent literature. For instance, crosslinkable compositions comprising alkenyl-functional organosiloxanes, methyl-hydrogenpolysiloxanes, and a suitable catalyst are known from U.S. Pat. No. 3,445,450. Furthermore, U.S. Pat. No. 4,476,166, U.S. Pat. No. 4,504,645, U.S. Pat. No. 4,609,574, and U.S. Pat. No. 5,145,932 further refer to siloxane-containing coating materials for producing adhesive-repellent coatings. Stein et al. (J. of Applied Polymer Sci. 1993, 47, 2257) investigated the nature of the network obtained after the curing of various compositions comprising vinylsiloxane, hydrogensiloxane, platinum catalyst, and inhibitor.

Since the 1980s there have also been radiation-curing siloxane-containing coating materials on the market. A system composed of epoxy-containing siloxanes cures under UV radiation by a cationic curing mechanism. This system is referred to in: U.S. Pat. No. 4,421,904; U.S. Pat. No. 4,547,431; U.S. Pat. No. 4,952,657; U.S. Pat. No. 5,217,805; U.S. Pat. No. 5,279,860; U.S. Pat. No. 5,340,898; U.S. Pat. No. 5,360,833; U.S. Pat. No. 5,650,453; U.S. Pat. No. 5,866,261; and U.S. Pat. No. 5,973,020.

Another system cures by a free-radical polymerization mechanism following irradiation with UV or electron beams. Systems of this kind are referred to in, for example, patents U.S. Pat. No. 4,201,808, U.S. Pat. No. 4,568,566, U.S. Pat. No. 4,678,846, U.S. Pat. No. 5,494,979, U.S. Pat. No. 5,510,190, U.S. Pat. No. 5,552,506, U.S. Pat. No. 5,804,301, U.S. Pat. No. 5,891,530, and U.S. Pat. No. 5,977,282. In systems which cure by a free-radical mechanism the polymerizable groups are typically acrylic ester groups.

Production of Abhesive Coatings

Abhesive coatings are usually produced by applying a mixture of two or more organosilicon compounds to sheetlike backings of plastic, metal or paper and curing the applied coatings by guiding the coated backings in web form from roll to roll at high plant speeds, of several hundred meters per minute, depending on the particular system, through an oven, an electron beam unit or a UV unit.

Thus, for example, thermosetting release coatings are frequently multicomponent systems, composed typically of the following components:
a) A linear or branched dimethylpolysiloxane which is composed of about 80-200 dimethylpolysiloxane units and is stopped at the chain ends by vinyl-dimethylsiloxy units. Typical representatives are, for example, solvent-free, addition-crosslinking silicone oil having terminal vinyl groups, such as DEHESIVE® 921 or 610, both available commercially from Wacker-Chemie GmbH.
b) A linear or branched crosslinker which is typically composed of methylhydrogensiloxy and dimethylsiloxy units, the chain ends being saturated either with trimethylsiloxy groups or with dimethylhydrogensiloxy groups. Examples of typical representatives of this class of product include hydrogen polysiloxanes having a high reactive Si—H content, such as Crosslinkers V24, V90 or V06, available commercially from Wacker-Chemie GmbH (Munich, Germany).
c) A silicone-MQ resin, which as the M unit possesses not only the trimethylsiloxy units used typically but also vinyldimethylsiloxy units. Examples of typical representatives from this group include the release-force regulators CRA®17 or CRA®42, available commercially from Wacker-Chemie GmbH (Munich, Germany).
d) A silicone-soluble platinum catalyst, such as a platinum-divinyltetramethyldisiloxane complex, referred to typically as the Karstedt complex and available, for example, under the designation Catalyst OL from Wacker-Chemie GmbH (Munich, Germany).

In addition there are a range of different additives which influence defined properties of siloxane release systems, producing, for example, improved adhesion to the substrate. It is frequently desirable, moreover, to make the release coating matt. One of the ways of achieving this is by incorporating particles into the coating material, such as silicas, for example. Use is also made of antimisting additives, which reduce the formation of siloxane spray mist to a minimum. Further typical adjuvants include dyes, pigments, and other fillers.

Free-radically curable coating materials are also usually composed of two or more components. The prior art uses mixtures of two or more (meth)acrylated polysiloxanes with different chain lengths and/or types of modification (U.S. Pat. Nos. 6,548,568, 6,268,404, 6,548,568, Goldschmidt publication “TEGO® RC Silicones, Application Guide”, Goldschmidt product data sheets for the products TEGO® RC 902, RC 726, RC 711, RC 708, RC 709, RC 715, RC 706). A high molecular mass silicone acrylate with a low level of modification is responsible principally for the release properties, while silicone acrylates with high levels of modification ensure effective substrate adhesion. Further constituents are frequently photoinitiators, which initiate the free-radical reaction as soon as the coating material is irradiated with UV light. Moreover, one or more organic (meth)acrylated compounds may be added, as an adhesion component or reactive diluent, for example, and also particles, such as silicas, which render the release coating matt, to one or to a mixture of two or more (meth)acrylated polysiloxanes.

Cationically crosslinking systems as well are frequently multicomponent systems. Mostly use is made of mixtures of different siloxanes which have been modified with vinylcyclohexene oxide. The photoinitiators used in this case are mostly iodonium salts. Further possible constituents may be organic vinyl ethers, which serve for example as diluents or as an adhesion additive, and also fillers, which have the effect, for example, of rendering the release coating matt.

The various processes for producing release coatings possess individual advantages and disadvantages. Thus, for example, in the case of thermally initiated addition-crosslinking coating materials, it is possible to employ platinum catalysts which typically require a few seconds of a temperature increase at least to 70-150° C. in order to activate the reaction. Consequently the selection of the substrates is limited to materials that are insensitive to temperature. It would therefore be desirable to carry out the thermal initiation as gently as possible, with a low temperature load on the substrate, in order thereby to enlarge the scope of application.

The curing of cationically or free-radically curing coating materials with electron beams necessitates relatively expensive plant. For the curing of such systems, therefore, UV units are frequently preferred. UV units, however, possess the disadvantage that infrared radiation is generated as well, and has to be removed by water cooling or air cooling, which is costly and inconvenient. Moreover, the outgoing air contains significant quantities of ozone, and the medium-pressure mercury vapor lamps that are employed pose a waste-disposal problem. Furthermore, the application-ready coating materials are sensitive to sunlight, as a result of the presence of the photoinitiator, with the result that their storage properties are restricted.

Microwaves

Microwaves are electromagnetic waves which are of much lower energy than UV radiation. When materials are irradiated with microwaves, these microwaves are converted into thermal energy, owing to the corresponding properties of the materials. This conversion is dependent on the specific material, on temperature, and on frequency. The critical factor for the effectiveness of the energy conversion is the imaginary component of the dielectric coefficient. Substances which are particularly suitable for the absorption of microwaves are therefore those of particularly high polarity. For example, the water molecule, owing to the angle between its atoms, is so polar that heating by microwaves is easily possible. In this case the high-frequency alternating field sets the polar molecule in rotation and hence converts the electromagnetic energy into heat.

For the purpose of heating, microwave technology has essentially three frequencies at its disposal, it being possible for these frequencies to differ somewhat from the figures stated, as a function of rules specific to a particular country. The highest frequency is 28 or 30 GHz. At the present time there is no prospect of large-scale, cost-effective industrial deployment of this frequency. The lower frequency of 915 MHz is subject to a certain technical cost and inconvenience, which justifies its use only for specific cases. The frequency which can be technically implemented at least expense is 2.45 GHz. This frequency is already in worldwide use in high quantities, in the form of household microwave ovens.

There are now also devices suitable for microwave irradiation of large surface areas. For example, microwaves are being used to dry wood and buildings. Structural components can be heated by means of microwaves within a very short time, with the moisture present evaporating.

Polymerizations With Microwaves

There are a series of chemical reactions known from the literature which are promoted by irradiation with microwaves. They include polymerizations. There are references, for example, of the formation of polyamides (Imai, Nemoto, Watanabe, Kakimoto, Polym. J. 1996, 28, 256), polyimides (Imai, ACS Symp. Ser. 1996, 624, 421), polyesters (Keki, Bodnar, Deak, Zsuga, Macromol. Rapid Commun. 2001, 22, 1063) or polyacrylates (Teffal, Gourdenne, Eur. Polym. J. 1983, 19, 543).

The systems listed are all organic systems, with which, predominantly, substrates having a high polarity are employed, since these substrates are readily excitable by means of microwaves. Siloxane-containing coating materials used for producing release coatings are notable in contrast, on account of their high siloxane content, for a non-polar character. It is only this non-polarity that gives the release coating its abhesive effect.

### DESCRIPTION OF THE INVENTION

Surprisingly it has now been found that microwaves are suitable also for producing siloxane-containing release coatings, when the siloxane-containing coating materials are cured by irradiation with microwaves. This applies not only to coating materials which cure on the basis of a thermally initiated or catalyzed addition reaction but also to those which cure by a free-radical or cationic polymerization.

Since any excitable molecule converts the microwave radiation into heat, and since microwaves are highly penetrating, the entire volume of the coating material is heated. This is a substantial advantage over conventional heating, with which the heat can penetrate into the mass only via the surface of the material, meaning that there must be a certain level of thermal conductivity present in order to obtain reasonable heating. This means as well that the substrate is always heated as well and hence is subject to a temperature load. In the case of microwave-induced curing, the coating material can be heated specifically without substantial heating of the substrate.

This invention accordingly provides a process for producing siloxane-containing release coatings which comprises curing a siloxane-containing coating material by irradiation with microwaves.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

The siloxane-containing coating materials which can be used in accordance with the invention comprise a high level of siloxanes that contain reactive groups which are curable by at least one of the mechanisms indicated above.

The release coatings described in the literature set out above, and the respective catalysts and/or initiators, can also be used in accordance with the invention.

The content of the abovementioned literature and patents relating to the chemical characterization of the siloxane-containing coating materials that contain reactive groups, and also to the initiators and catalysts that can be used with them, is therefore hereby incorporated by reference to be part of the disclosure content of the present application.

It may be of advantage to incorporate additives that are easily heatable by microwaves into the coating material. These may be particles, including mixtures of different particles. Suitable particles are, in particular, particulate inorganic solids having polar surfaces. The size of such particles is variable. Particularly suitable particles are those having an average size of up to 5 μm. Inorganic particles of this kind may be composed of metal compounds or semimetal compounds. Examples are (hydrated or unhydrated) oxides, phosphates, stannates, spinels, ferrites or mixed oxides. Particularly advantageous for use in non-matted release coatings, which typically possess a thickness of about 0.5 to 2 μm, are nanoscale particles. Particular suitability is possessed by silicas, and especially by nanoscale silicas which are distinguished by a polar surface. Nanoscale particles are particles with a diameter of less than 100 nm.

In addition it is possible to introduce polar organic compounds into the coating material. Suitable examples include polyethers or polyethersiloxanes, for accelerating the curing reaction.

Likewise suitable are ionic substances, especially ionic liquids or ionically modified siloxanes such as ammonium-functional siloxanes, for example. These polar substances, particularly the ionic compounds, can also be incorporated into the coating materials, by first applying them to the surface of particles.

The additives listed which are easily heatable by microwaves represent merely examples and not a restriction in the sense of this invention.

Since the coating materials, where appropriate with the use of the microwave-excitable additives listed, are heated by irradiation with microwaves, it may be sensible to add another, customary prior-art catalyst or initiator to the system. When using free-radically curable, siloxane-containing coating materials, for example, it is sensible to replace some or all of the conventional photoinitiators by initiators which can be activated thermally, such as 2,2′-azobisisobutyro-nitrile (AIBN), benzoyl peroxide, dilauroyl peroxide or dicumyl peroxide, for example. The same applies mutatis mutandis to the other systems.

In the case of thermal curing it may be sensible to use specific transition metal catalysts whose ligands are substituted or eliminated by microwave irradiation. Thermally, however, such transition metal catalysts should have sufficient stability to ensure effective handling of the coating material in its application-ready form.

The invention is further described by the following non-limiting examples which further illustrate the invention, and are not intended, nor should they be interpreted to, limit the scope of the invention.

### EXAMPLES

In order to identify siloxane-containing coating materials which can be cured by microwaves, model experiments were first carried out using a CEM Discover microwave. For testing purposes, 8 mL samples of a silicone-containing coating material were placed in a 10 mL glass tube and irradiated.

### Example 1

70 g of Tego RC 902 (α,ω)-modified silicone acrylate, available commercially from Degussa AG) were mixed with 30 g of Tego RC 711 (silicone acrylate with a high level of lateral modification, available commercially from Degussa AG) and 2 g of AIBN. 8 mL of this mixture were then placed in a 10 mL glass tube and irradiated for 2 minutes with a microwave power of 200 W. The reaction chamber was rendered inert using nitrogen. It was found that the mixture cured completely.

### Example 2

70 g of Tego RC 902 (α,ω)-modified silicone acrylate, available commercially from Degussa AG) were mixed with 30 g of Tego RC 711 (silicone acrylate with a high level of lateral modification), 2 g of Aerosil 200 (hydrophilic pyrogenic silica, available commercially from Degussa AG), and 2 g of AIBN. 8 mL of this mixture were then placed in a 10 mL glass tube and irradiated for 1 minute with a microwave power of 200 W. The reaction chamber was rendered inert using nitrogen. It was found that the mixture cured completely.

### Example 3

70 g of Tego RC 902 (α,ω-modified silicone acrylate, available commercially from Degussa AG) were mixed with 30 g of Tego RC 711 (silicone acrylate with a high level of lateral modification), 2 g of Aerosil 200 (hydrophilic pyrogenic silica, available commercially from Degussa AG), and 2 g of AIBN. 8 mL of this mixture were then placed in a 10 mL glass tube and irradiated for 1 minute with a microwave power of 200 W. The reaction chamber was not rendered inert. It was found that the mixture cured only partly.

### Example 4

100 g of DEHESIVE 929 (vinylsiloxane, available commercially from Wacker AG) were mixed with 7.19 g of Crosslinker V 06 (SiH-functional siloxane, available commercially from Wacker AG) and 1.07 g of Catalyst OL (100 ppm Pt). 8 mL of this mixture were then placed in a 10 mL glass tube and irradiated with a microwave power of 300 W. It was found that the mixture was completely cured only after an irradiation time of 2 minutes.

### Example 5

100 g of DEHESIVE 929 (vinylsiloxane) were mixed with 7.19 g of Crosslinker V 06 (SiH-functional siloxane) and 1.07 g of Catalyst OL (100 ppm Pt). 8 mL of this mixture were then placed in a 10 mL glass tube and irradiated with a microwave power of only 100 W. It was found that the mixture was completely cured after just 1 minute.

### Example 6

100 g of RC 1402 (epoxy-modified siloxane, available commercially from Degussa AG) were mixed with 4 g of Tego PC 1465 (50% strength solution of an iodonium salt, available commercially from Degussa AG) and 2 g of AIBN. 8 mL of this mixture were then placed in a 10 mL glass tube and irradiated for 2 minutes with a microwave power of 300 W. It was found that the mixture cured completely.

### Example 7

95 g of RC 1402 (epoxy-modified siloxane) were mixed with 5 g of polypropylene oxide (average molar mass 1000 g/mol) and 4 g of Tego PC 1465 (50% strength solution of an iodonium salt). 8 mL of this mixture were then placed in a 10 mL glass tube and irradiated for 2 minutes with a microwave power of only 150 W. It was found that the mixture cured completely.

Performance Testing:

For the testing of the performance properties, the curable coating materials set out in the examples above were applied to sheetlike backings (oriented polypropylene film) and an area measuring 6×6 cm was cut out and irradiated in the microwave apparatus described above. The coating weight in each case is approximately 1 g/m².

The release force of these coatings was then measured using a 25 mm wide adhesive tape which is coated with an acrylate adhesive and is available commercially from Beiersdorf as TESA® 7475. To measure the abhesiveness these adhesive tapes are rolled onto the substrate and then stored at 40° C under a weight of 70 g/cm². After 24 hours a measurement is made of the force required to remove the respective adhesive tape from the substrate at a speed of 30 cm/min and a peel angle of 180° C. This force is termed the release force. The general test procedure corresponds essentially to test method No. 10 of the Fédération Internationale des Fabricants et Transformateurs D'Adhésifs et Thermocollants sur Papier et autres Supports (FINAT).

The subsequent adhesion is determined very largely in accordance with FINAT test specification No. 11. For this purpose the adhesive tape TESA® 7475 from Beiersdorf is rolled onto the substrate and then stored at 40° C. under a weight of 70 g/cm². After 24 hours the adhesive tape is separated from the release substrate and rolled onto a defined substrate (steel plate, glass plate, film). After one minute a measurement is made of the force required to remove the adhesive tape from the substrate at a speed of 30 cm/min and a peel angle of 180° C. The resulting measurement is divided by the value for the same measurement on an untreated adhesive tape under otherwise identical test conditions. The result is termed the subsequent adhesion and is expressed in general as a percentage. Figures above 80% are considered by the skilled worker to be sufficient, and suggest effective curing.

| | Release force | Subsequent |
|---|---|---|
| | TESA 7475 | adhesion |
| Example | [cN/inch] | [%] |
| 1 | 15 | 79 |
| 2 | 12 | 85 |
| 3 | 6 | 56 |
| 4 | 12 | 82 |
| 5 | 11 | 92 |
| 6 | 16 | 76 |
| 7 | 12 | 86 |

The performance testing shows that it is possible to produce siloxane-containing release coatings having good properties by irradiation with microwaves. It is also apparent that it can be of advantage to incorporate additives which are readily heatable by microwaves into the coating material (comparative examples 1 and 2, 4 and 5, 6 and 7). As with UV curing as well, an inert environment is advantageous in the case of free-radical microwave curing (comparative examples 2 and 3).

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A process for producing siloxane-containing release coatings by curing a siloxane-containing coating material by irradiation with microwaves.

2. A process as claimed in claim 1, wherein the siloxane-containing coating materials comprise one or more thermosetting compounds.

3. The process as claimed in claim 2, wherein the siloxane-containing coating materials comprise one or more compounds selected from the group consisting of vinyl-functional siloxanes and siloxanes containing SiH groups.

4. A process as claimed in claim 1, wherein the siloxane-containing coating materials comprise one or more free-radically curing compounds.

5. A process as claimed in claim 4, wherein the siloxane-containing coating materials comprise one or more (meth)acrylate-functional siloxanes.

6. A process as claimed in claim 1, wherein the siloxane-containing coating materials comprise one or more cationically curing compounds.

7. A process as claimed in claim 6, wherein the siloxane-containing coating materials comprise one or more epoxy-functional siloxanes.

8. The process as claimed in claim 1, wherein the coating materials comprise one or more organic and/or one or more inorganic particles having polar surfaces.

9. The process as claimed in claim 8, wherein silica is used as particles.

10. The process as claimed in claim 1, wherein the coating materials comprise one or more ionic compounds.

11. The process as claimed in claim 10, wherein ionic liquids are used as ionic compounds.

12. The process as claimed in claim 10, wherein ionically modified siloxanes are used as ionic compounds.

13. The process as claimed in claim 12, wherein quaternary ammonium-modified siloxanes are used as ionic compounds.
